(19) United States
(12) Patent Application Publication
(10) Pub. No.: US 2019/0276188 A1
(43) Pub. Date: Sep. 12, 2019

(54) BARREL AND COVER ASSEMBLY WITH LIMITED CONTACT

(71) Applicant: Cryovac, LLC, Charlotte, NC (US)

(72) Inventors: Suhendra Kartika, Taylors, SC (US); Robert Babrowicz, Spartanburg, SC (US); Laurie Ballenger, Greer, SC (US)

(21) Appl. No.: 16/347,038

(22) PCT Filed: Nov. 3, 2017
(86) PCT No.: PCT/US2017/059917

§ 371 Date: May 2, 2019

Related U.S. Application Data
(60) Provisional application No. 62/416,898, filed on Nov. 3, 2016.

(51) Int. Cl. B65D 25/36; C12H 1/22; B65D 75/00; B65D 71/06; B32B 21/08; B65D 85/72; B65D 8/00

(52) U.S. Cl. CPC B65D 25/36; C12H 1/22; B65D 75/006; B32B 27/32; B32B 21/08; B65D 85/72; B65D 7/045; B65D 71/063

(57) ABSTRACT

Barrel-with-cover assembly has a barrel and a cover covering at least a portion of the barrel outside surface. Cover has at least one open end. A means for gathering the cover maintains the open end of the cover in limited contact against the outer surface of the barrel. This limited contact, alone or in combination with a liquid exit port, allows liquid that collects between the cover and the barrel to escape, reducing hoop rusting. The assembly is used in a process for aging an alcoholic beverage in the barrel. The film from which the cover is made can have a low ethanol transmission rate and a high oxygen transmission rate, producing organoleptic results similar to uncovered control barrel.

### FIELD

The present invention is directed to the wooden barrel aging of alcoholic beverages such as distilled spirits, wine, and beer, in which the barrel is covered by an article which allows the beverage to age in the normal manner while at the same time reducing the Angels Share loss resulting from liquid passing through the barrel and evaporating into the atmosphere.

### BACKGROUND

The present invention is directed to the wooden barrel aging of alcoholic beverages such as distilled spirits, wine, and beer. During typical wooden barrel aging of distilled spirits derived from grains and other farm sources, from 2 to 50 wt % or more of the distilled ethanol and water in the mixture diffuses between and through the wooden barrel components (staves and heads) and thereafter evaporates into the surrounding atmosphere. The diffusion and evaporation continues throughout the aging period, which can be from a few weeks or months up to 20 years or more. The extent of evaporation depends on the initial alcohol content of the distillate or fermented product, the duration of aging in the wooden barrels, the condition of the barrels, ambient conditions, etc. The alcoholic beverage industry defines this loss as the “angels' share.”

The amount of water, ethanol, etc lost through evaporation when aging distilled spirits in 53 gallon white oak barrels over periods of time ranging from 1 to 20+ years ranges from about 2% per year to about 10% per year, depending upon the ambient conditions during aging, e.g., depending upon the climate. The distillate may be weaker upon emerging from the distillation process than it is after aging for 10 years, as ethanol loss can be greater than water loss. The loss of ethanol during aging has adverse effects over and above the loss of the alcohol itself. The release of alcohol into the atmosphere around the barrels may produce an explosion hazard, as a high ethanol content in the air may ignite explosively if subjected to spark or flame. Evaporated ethanol released into the ambient environment also serves as sustenance for black fungi and/or molds growing on warehouse walls, adjacent buildings, cars, etc.

For many decades, distillers have attempted to reduce the angels' share during aging of distilled spirits and wine in wooden casks. Barrels have been provided with coatings, including coating of the outer surface of barrel staves and/or barrel heads. Bonding agents have been used between the staves. Barrels have been made from reconstructed staves having intermediate plies of non-porous material. Barrels have been placed inside bags made from various films, with or without evaporation of atmosphere from the bag before it is sealed closed.

It has been found that aging an alcoholic beverage in a barrel by completely enclosing the beverage-containing barrel in a packaging article comprising a film which is specifically designed for low ethanol transmission but relatively high oxygen transmission, allows the alcoholic beverage to age normally while at the same time significantly reducing Angels Share loss. Such a film, and its use around an alcoholic beverage aging barrel, are disclosed in U.S. Ser. No. 14/599,820, entitled “Process For Reducing Ethanol Loss While Developing Desirable Organoleptics During Wooden Barrel Aging Of Alcoholic Beverage,” filed 19 Jan. 2015, and U.S. Ser. No. 14/333,867, entitled Process For Reducing Ethanol Loss While Developing Desirable Organoleptics During Wooden Barrel Aging Of Alcoholic Beverage,” filed 17 Jul. 2014, both of which are hereby incorporated, in their respective entireties, by reference thereto.

However, it has been discovered that hermetically sealing such a film around an alcoholic beverage containing barrel may in at least some cases allow liquid to accumulate and remain between the outside surface of the barrel and the inside surface of the packaging article. The water in this outside-the-barrel liquid causes the barrel to appear to be wet, which is at least aesthetically undesirable. The presence of moisture between barrel and packaging article is also believed to contribute to rusting of the iron hoops around the barrel. The rusting of the iron hoops is believed to be at least part of the cause of the liquid turning an unsightly dark color. In addition to the adverse aesthetic effect of retaining dark liquid between the film and the outside surface of the barrel, the retained liquid between the outside of the barrel and the inside of the film has the potential of at least partially migrating back into the barrel and adversely affecting the organoleptics and/or color of the alcoholic beverage as it ages inside the barrel.

It would be desirable to find a way to age an alcoholic beverage in a manner that reduces the Angels Share while at the same time avoiding (i) retention of liquid between the barrel and an Angels Share reduction packaging article surrounding part or all of the barrel and any accompanying detrimental effects upon the beverage inside the barrel or detrimental effects on the barrel itself, and (ii) avoiding any accelerated rusting of the barrel hoops.

### SUMMARY

A limited contact assembly and process for making and using same have been discovered which can reduce the Angels Share loss while also reducing or eliminating the retention of fluid between the barrel and film around the barrel, and the associated potential for increased rusting of the iron barrel hoops, while at the same time allowing the liquid contents inside the barrel to age in a manner that generates organoleptic development in accordance with traditional, uncovered barrel aging. Moreover, the use of the limited contact assembly eases the process of covering part or all of the barrel with a cover.

It has been discovered that by having the tubular cover in limited contact with the barrel allows liquid between barrel and film to escape, as liquid or vapor, through passageways in the region in which the tubular cover is in limited contact with the barrel, thereby: (i) reducing or eliminating hoop rusting, (ii) reducing or eliminating the unsightly appearance of liquid trapped between the barrel and film, and (iii) reducing or eliminating any detrimental effect(s) which may occur due to the presence of the liquid between the barrel and the tubular cover. Moreover, it has been found that a significant portion of the reduction of Angels Share losses is maintained in spite of the open system present with limited contact between cover(s) and barrel.

At the same time that the passageways for escape of liquid allow avoidance of these detrimental effects, having the film (i.e., tubular cover) covering at least a portion of the barrel maintains a high ethanol concentration in the micro-environment between the barrel and the film, with relatively low rate of ethanol loss through the unsealed contact between the film and the barrel, compared with the rate of ethanol loss which would occur without the film covering the barrel. Maintaining a higher ethanol concentration in the micro-environment between the barrel and the film provides a micro-climate in which the gas surrounding the barrel is closer to being saturated with ethanol, thereby reducing the rate of evaporation of ethanol which has migrated to the surface of the barrel, with accompanying lowering of the Angels Share loss of ethanol to the environment, providing the multiple advantages of greater quantity of aged alcoholic beverage, lower explosion hazard, and lower rate of mold growth due to lower concentration of ethanol in the atmosphere.

A first aspect is directed to a barrel-with-cover assembly comprising a barrel and a tubular cover positioned over and covering at least a portion of an outside surface of the barrel. The barrel comprises a top head and a bottom head, and a plurality of wooden staves each contacting and extending between the top head and the bottom head, each of the wooden staves having an upper end and a lower end. The wooden staves are maintained in lengthwise contact with one another by a plurality of metal hoops around an outside surface of the staves, the barrel having a maximum transverse circumference at a barrel bilge. The tubular cover is positioned over and covers at least a portion of an outside surface of the barrel including at least a portion of the outside surface of the staves. The tubular cover has at least one open end having a perimeter greater than a maximum outside circumference of the outer surface of the barrel. The open end of the tubular cover is maintained in limited contact against the outer surface of the barrel by means for gathering the tubular cover.

In an embodiment, in the barrel-with-cover assembly, the barrel contains a liquid comprising ethanol.

In an embodiment, in the barrel-with-cover assembly, the tubular cover is a pouch having a first end which is a closed end and a second end which is the open end.

In an embodiment, the tubular cover has a closed end which is a separate end piece of which is fastened to the tubular cover. The separate piece can be attached to the outside surface of the tubular cover or the inside surface of the tubular cover, or even fastened to the tubular cover with a separate tape, which can be a pressure sensitive tape or to which the tubular cover and the closed end piece are both fastened. The tubing and the end piece may both be made of film. Having a separate end piece of film to provide the closed end of the tubing portion of the cover.

In an embodiment, in the barrel-with-cover assembly comprising a first tubular cover and a second tubular cover. The first end of the first tubular cover is closed and covers the top head of the barrel with the barrel in an upright position. The means for gathering the first tubular cover is a first means for gathering the first tubular cover and is at the open second end of the first tubular cover. The first tubular cover covers the staves to a position below the barrel bilge. The second tubular cover has a second closed end that covers the bottom head of the barrel with the barrel in the upright position. The second tubular cover has a second means for gathering the second tubular cover at a second open end of the second tubular cover. The second tubular cover covers the staves to a position above the first means for gathering the first tubular cover at the first open end of the first tubular cover. The second tubular cover overlaps the first tubular cover. In an embodiment, at least a portion of the second tubular cover covering the bottom head comprises a liquid exit port. In an embodiment, the second open end of the second tubular cover is outside the first open end of the first tubular cover. In an embodiment, the second open end of the second tubular cover is inside the first open end of the first tubular cover.

In an embodiment, the tubular cover is a first tubular cover having a closed first end covering the bottom head of the barrel with the barrel in an upright position, and the means for gathering is a first means for gathering at the open end of the first tubular cover, with the open end of the first tubular cover covering the staves to position above the barrel bilge. The barrel-with-cover assembly further comprises a second tubular cover with a second closed end covering the top head of the barrel with the barrel in an upright position. The second tubular cover has a second means for gathering at a second open end of the second tubular cover. The second tubular cover overlaps the first tubular cover. The second open end of the second tubular cover covers the staves to position below the first means for gathering at the first open end of the first tubular cover. In an embodiment, at least a portion of the first tubular cover covering the bottom head comprises a liquid exit port. In an embodiment, the second open end of the second tubular cover is outside the first open end of the first tubular cover. In an embodiment, the second open end of the second tubular cover is inside the first open end of the first tubular cover.

In an embodiment, the means for gathering the tubular cover is at the open end of the tubular cover which is a first open end of the tubular cover, and the tubular cover further comprises a second open end and a second means for gathering the tubular cover at the second open end of the tubular cover.

In an embodiment, in the barrel-with-cover assembly comprising a first tubular cover, a second tubular cover, and a third tubular cover. The first tubular cover that covers the barrel bilge, and the open end is a first open end of the first tubular cover with the first open end of the first tubular cover being between the barrel bilge and the lower end of the wooden staves with the barrel in the upright position with the first means for gathering the first tubular cover being at the first open end of the first tubular cover, the first open end of the being maintained in limited contact against the outer surface of the barrel by the means for gathering at the first open end of the first tubular cover, with the first tubular cover further comprising a second open end which is between the barrel bilge and the upper end of the wooden staves with the barrel in the upright position, with the second means for gathering the first tubular cover being at the second open end of the first tubular cover, the second open end being maintained in limited contact against the outer surface of the barrel by a second means for gathering at the second open end of the first tubular cover. The second tubular cover has a first closed end covering the top head of the barrel with the barrel in an upright position and a third open end opposite the first closed end. The second tubular cover overlaps the first tubular cover. The second tubular cover has a third means for gathering at a third open end of the second tubular cover, with the third open end being maintained in limited contact against the outer surface of the barrel staves by a third means for gathering at the third open end of the second tubular cover. The third tubular cover has a second closed end covering the bottom head of the barrel with the barrel in an upright position and a fourth open end opposite the second closed end. The third tubular cover overlaps the first tubular cover. The third tubular cover has a fourth means for gathering at the fourth open end of the third tubular cover, with the fourth open end being maintained in limited contact against the outer surface of the barrel by a forth means for gathering at the fourth open end of the third tubular cover. In an embodiment, at least a portion of the third tubular cover covering the bottom head comprises a liquid exit port.

In an embodiment, the third open end of the second tubular cover is outside the second open end of the first tubular cover. In an embodiment, the first open end of the first tubular cover is outside the fourth open end of the third tubular cover.

In an embodiment, the third open end of the second tubular cover is inside the second open end of the first tubular cover. In an embodiment, the fourth open end of the third tubular cover is outside the first open end of the first tubular cover.

In an embodiment, the tubular cover, or at least one of the plurality of tubular covers, is a backseamed tubing comprising a backseam of the film to itself and an inside surface of the tubing is heat sealed to itself to form the closed first end. In an embodiment, the backseam is a fin seal of the inside of the film to itself. In an embodiment, the backseam is a lap-seal of the outside of the film to the inside of the film.

In an embodiment, the tubular cover covers at least 75% of an outer surface of the staves.

In an embodiment, the at least one means for gathering comprises at least one member selected from the group consisting of an elastic strap, a clip, a staple, a pin, an adhesive, drawstring, tape with pressure sensitive adhesive, touch fastener, hook-and-loop fastener, hook-and-pile fastener, slidingly engaging fastener, bundle tie, and a clamp.

In an embodiment, the means for gathering the tubular cover is an elastic strap in contact with the tubular cover, and a portion of the film is held in limited contact with the barrel by the contractive force exerted by the elastic strap. In an embodiment, the elastic strap is present as an elastic loop, with the elastic loop having a relaxed length smaller than a circumference of the barrel at the upper end of the staves and the lower end of the staves.

In an embodiment, at least one of the open ends of at least one tubular cover doubles back upon itself to form a first casing defining a first casing enclosure having a first elastic strap present within the first casing enclosure.

In an embodiment, the elastic loop comprises a first end portion of the elastic strap fastened to a second end portion of the elastic strap.

In an embodiment, the elastic strap is attached to an outside surface of the tubular cover. In an embodiment, the elastic strap is attached to an inside surface of the tubular cover.

In an embodiment, the barrel-with-cover assembly further comprises a pallet with the barrel in the upright position, the barrel resting upon an upper surface of the pallet. In an embodiment, the barrel-with-cover assembly further comprises a tray between the pallet and the barrel.

In an embodiment, a portion of the tubular cover extends down to cover an edge of the tray under the barrel or to cover or be covered by a portion of the tray extending upward over a lower portion of the outer surface of the barrel, with the means for gathering the tubular cover comprising an elastic band around the tray, with the elastic band: (i) in contact with the tubular cover and forcing the tubular cover into a gathered configuration against the edge of the tray, or (ii) in contact with the tubular cover and forcing the tubular cover into a gathered configuration against the upwardly extending portion of the tray, or (iii) in contact with the upwardly extending portion of the tray which in turn forces the open end of the tubular cover into a gathered configuration against the outer surface of the barrel.

In an embodiment, the barrel tray or trays or the pallet tray comprises at least one member selected from the group consisting of cardboard (including moisture-resistant cardboard), wood, plastic sheet, plastic film. In an embodiment, the pallet has a plurality of barrels resting upon the upper surface thereof, each barrel resting in the upright position. In an embodiment, each barrel rests upon its own barrel tray. In an embodiment, the barrel-with-cover assembly further comprises a pallet tray covering an entirety of the upper surface of the pallet, with each of the barrels resting upon the pallet tray.

In an embodiment, each barrel on the pallet has the tubular cover thereover, and the barrels are present in the assembly in a number which equals the number of tubular covers in the assembly.

In an embodiment, each barrel on the pallet has two tubular covers thereover, and the barrels are present in the assembly in a number which half the number of tubular covers in the assembly.

In an embodiment, each barrel on the pallet has three tubular covers thereover, and the barrels are present in the assembly in a number which equals one third the number of tubular covers in the assembly.

In an embodiment, at least one of the at least one tubular covers comprises at least one gusset.

In an embodiment, the tubular cover is a seamless tubing having an inside surface which is heat sealed to itself to form the closed end.

In an embodiment, at least one of the at least one tubular covers having the closed end and the open end is a lay-flat article comprising an end seal.

In an embodiment, at least one of the at least one tubular covers having the closed end and the open end is a lay-flat article comprising a pair of side seals and the closed end is a seamless fold.

A second aspect is directed to a process for aging an alcoholic beverage in a wooden barrel, comprising (a) filling an empty wooden barrel with an alcoholic beverage to produce a filled wooden barrel (b) closing the wooden barrel after filling the barrel, to make a sealed, filled barrel; (c) covering at least a portion of the wooden barrel by placing at least one tubular cover thereover, to produce a barrel-with-cover assembly, and (d) aging the alcoholic beverage in the barrel-with-cover assembly. The barrel comprises a top head and a bottom head, and a plurality of wooden staves each contacting and extending between the top head and the bottom head, each of the wooden staves having an upper end and a lower end. The wooden staves are maintained in lengthwise contact with one another by a plurality of metal hoops around an outside surface of the staves. The barrel has a maximum transverse circumference at a barrel bilge. The barrel-with-cover assembly is in accordance the first aspect described above, and can be in accordance with any embodiment of the first aspect, described above.

In an embodiment, the process further comprises placing the empty wooden barrel on top of a pallet before filling and closing the barrel. The filling can take place before or after covering the barrel with the tubular cover.

In an embodiment, the process further comprises providing a barrel tray or pallet tray between the pallet and the empty wooden barrel. The barrel tray or pallet tray can be provided before placing the barrel on the tray. The barrel tray or pallet tray can be provided before or after covering the barrel with the tubular cover.

In an embodiment, the barrel is filled with the alcoholic beverage before the barrel is at least partially covered by the at least one tubular cover.

In an embodiment, the barrel is at least partially covered by the at least one tubular cover before the barrel is filled with the alcoholic beverage.

In an embodiment, the tubular cover is a first tubular cover, the closed end is a first closed end, and the open end is a first open end, and the process further comprising placing a second tubular cover over the top head of the barrel, the second tubular cover having a second closed end covering the top head of the barrel and a second open end overlapping the first open end, the second open end being maintained in limited contact against the outer surface of the barrel by a second means for gathering the second tubular cover.

In an embodiment, the process further comprises placing the empty wooden barrel on a pallet before filling the empty wooden barrel with the alcoholic beverage.

In an embodiment, the process further comprises providing a barrel tray between the pallet and the barrel.

In an embodiment, the process further comprises providing a pallet tray between the pallet and the barrel.

In an embodiment, the first closed end of the first tubular cover comprises a liquid exit port.

### BRIEF DESCRIPTION OF THE DRAWINGS

FIG. 1 is a schematic of a wooden barrel as used for the aging of alcoholic beverages.

FIG. 2 is a perspective view of a schematic of a covered wooden barrel on a pallet.

FIG. 3 is an enlarged view of a portion of the covered wooden barrel on a pallet, illustrated in FIG. 2, with a means for gathering comprising an elastic strap loop inside a casing at an open end of the cover.

FIG. 4 is a perspective view of a schematic of four covered wooden barrels on a pallet.

FIG. 5A is a perspective view of a barrel pad or pallet pad which is foldable.

FIG. 5B is a perspective view of the barrel pad or pallet pad of FIG. 5A, in folded configuration.

FIG. 6A is a perspective view of a schematic of an alternative barrel-with-cover assembly.

FIG. 6B is a perspective view of a schematic of a different alternative barrel-with-cover assembly.

FIG. 7 is a schematic of a cross-sectional view of cover having an open end with a casing and an elastic strap inside an enclosure formed by the casing.

FIG. 8 is a schematic longitudinal cross-sectional view of an alternative barrel-with cover assembly comprising three covers.

FIG. 9 is a schematic of a cross-sectional view of a cover held in limited contact with a barrel with a means for gathering comprising a pin.

FIG. 10 is a schematic of a cross-sectional view of a region of a cover including a folded region, with the folded region being in limited contact with a barrel with a means for gathering comprising a tape having a pressure sensitive adhesive thereon.

FIG. 11 is a schematic of a cross cross-sectional view of a cover held in limited contact with a barrel with a means for gathering comprising an elastic band.

### DETAILED DESCRIPTION

As used herein, the phrases “top head” and “bottom head” refer to opposing heads (i.e., a first head and a second head) of a barrel, regardless of whether the barrel is in an upright position (i.e., vertical position, i.e., axis through centers of barrel heads in a vertical position), resting on one end thereof, or whether the barrel is in a horizontal position (i.e., axis through centers of barrel heads in horizontal position), with the bilge in contact with a support surface. Similarly, as used herein, the phrases “upper end” and lower end,” used relative to the wooden staves, refer to opposing ends of the staves (i.e., a first end and a second end), regardless of whether the barrel is in an upright (vertical position) resting on one end thereof, or whether the barrel is in a horizontal position, with the bilge in contact with a support surface.

On the other hand, in the instances in which the barrel or the barrel-and-cover assembly is described as being in an upright position, the phrase “top head” refers to the barrel head at the so-oriented top of the barrel, and the phrase “bottom head” refers to the barrel head at the bottom of the so-oriented bottom of the barrel. Similarly, in the instances in which the barrel or the barrel-and-cover assembly is described as being in an upright position or vertical position, the “upper end,” used with reference to the staves, refers to the ends of the staves connected with the top head of the barrel. Likewise, in the instances in which the barrel or the barrel-and-cover assembly is described as being in an upright or vertical position, “lower end,” used with reference to the staves, refers to the ends of the staves connected with the so-oriented bottom head of the barrel.

As used herein, the phrase “means for gathering” refers to any and all means for maintaining at least a portion of the cover in a gathered configuration (i.e., wrinkled, undulating, accordioned, overlapping, condensed, etc) and/or maintaining a portion of the cover in a folded configuration (i.e., pleated configuration). The means for gathering may (i) apply force to cause the gathering of a portion of the cover, as per an elastic strap and some clamps, or (ii) merely maintain a previously gathered or folded configuration in place, as per a pin, staple, pressure sensitive adhesive tape, etc. The means for gathering may extend all the way around the barrel or around on a portion of the barrel.

The cover can be film in the form of a flat sheet that is draped over the barrel or barrels, with the means for gathering maintaining the cover in a gathered or folded configuration in limited contact with the outer surface of all the barrels being covered. A cover comprising a tubing is preferred because it has less excess film than a cover that is a flat sheet.

Alternatively, the cover can be a film in the form of a flat sheet draped over the barrel or barrels, or in the form of a tubing, without the means for gathering maintaining the cover in limited contact with the outer surface of all the barrels being covered. For example, if six barrels in upright position are arranged with their longitudinal axes at the corners of a hexagon, with a seventh barrel in the middle, the centrally positioned seventh barrel can be covered by the without being maintained in limited contact with the outer surface of the seventh barrel, but will be in limited contact with a portion of the outer surface of six covered barrels arranged in the hexagon pattern.

The means for gathering the tubular cover includes any means that gathers the tubular cover in a manner such that the tubular cover is held in limited contact with the barrel. Such means includes one or more of the following: elastic strap(s), clip(s), staple(s), pin(s), adhesive, and clamp(s). As used herein, the means for gathering can gather the excess film into a wrinkled configuration (such as an accordion configuration) or a folded configuration, i.e., with pleats, or a combination of a wrinkled configuration and a pleated configuration.

If the means for gathering comprises an elastic strap, the strap can be around the outside of the tubular cover, or affixed to the inside surface of the tubular cover, or confined inside a casing made by either folding the tubular cover back upon itself (i.e., folding to the inside or folding to the outside) and fastening the folded back portion to the remainder of the tubular cover and to form a casing enclosure. The elastic strap can go all the way around the open end of the tubing or only around a portion of the distance around the open end of the tubing.

Alternatively, the elastic strap can be used around a pad that the barrel rests upon when the barrel is in an upright position, with the pad resting upon the upper surface of a pallet. That is, the pad can be between the pallet and the barrel. The pad can have a portion which extends upward around the outside surface of one or more of the barrel staves. The elastic strap can be around the tubing, i.e., holding the tubing (i) in limited contact with the edge of the pad or (ii) in limited contact with an upwardly extending portion of the pad, or (iii) in limited contact with an upwardly extending portion of the pad which in turn holds the tubing against the staves of the wooden barrel.

The means for gathering can be an elastic strap that is present inside a casing enclosure provided at the open end of the tubular cover, i.e., the tubular article that covers the barrel. The casing includes all material surrounding the casing enclosure, including (i) any portion of the tubular material doubled back upon itself and a corresponding portion of the tubular cover doubled back upon to form the casing enclosure (ii) any separate article affixed to the inside or outside surface of the article together with a corresponding portion of the tubular cover covered by the separate article, and (iii) any separate article affixed to the outside surface of the tubular cover at a first location and fastened to the inside of the tubular cover at a second location, to provide a casing enclosure including the inside surface of the separate article and any portion of the tubular cover making up the inside surface of the casing enclosure.

An elastic band (i.e., elastic strap, elastic cord, elastic tape, elastic fabric, or elastic ribbon) positioned inside the casing enclosure can be used to hold the tubular cover in limited contact against the barrel. The elastic band can be sized so that it can be stretched to a size large enough to pass over the maximum transverse perimeter of the barrel (i.e., the barrel bilge), but so that it contracts to a size small enough to hold the film in limited contact with the barrel at a desired location to allow the tubular cover to cover a desired surface of the barrel.

As used herein, the phrase “limited contact” (also referred to herein as “unsealed contact”) refers to a level of contact which holds an end region of the cover against the barrel with the film being in a puckered and/or folded configuration, in which the film contact with the outside surface of the barrel is neither watertight nor airtight (i.e., “unsealed contact”), with the contact leaving a plurality of passageways for otherwise trapped liquid (i.e., liquid which (i) evaporates from the surface of the barrel and condenses between the film and the barrel, and/or (ii) passes through the barrel in the liquid state, due to a leak or other migration through the barrel in the liquid state. As used herein, “limited contact” includes holding the end region of the cover in direct contact with the wood of the wooden staves and/or directly against a metal hoop around the wooden staves, or directly against another tubular cover having one or more open ends which in turn are held directly against the wood of the wooden staves and/or directly against a metal hoop around the wooden staves.

The a liquid exit port can be perforations with or without hanging chads, slits, perforations, one or more valves (particularly one-way valves allowing fluid to exit but not enter or re-enter), or even passageways leading to a fully enclosed region separate from the chamber within which the barrel resides, the separate region having an absorbent to absorb and collect the fluid so that it does not migrate back out into the chamber in which the barrel resides, so that the fluid does adversely affect the barrel and/or the barrel hoops and/or the alcoholic beverage inside the barrel, be it comprising a distilled liquid product or a fermented liquid product therein.

In an embodiment, the cover has a closed end that covers the outside surface of a first barrel head and the outside surface of the staves, with the open end of the cover terminating at the stave ends connected to the second barrel head. Aging of the liquid in the barrel can be carried out with the covered, filled barrel in a horizontal position (as on warehouse racks) or in a vertical position, either stacked or with one or more barrels on a pallet. The covered barrel can be stored with the closed end of the cover covering the bottom head of the barrel, or with the closed end of the cover covering the top head of the barrel. If the closed end of the cover covers the bottom head of the barrel, the closed end of the cover can be provided with a liquid exit passageway.

In an embodiment, the tubular cover covers the outside surface of the first barrel head and the full length of the outside surface of the staves, and a portion of the second barrel head. The barrel can be stored for aging in a vertical orientation a horizontal orientation, or any orientation between vertical and horizontal.

In covering the first barrel head or both the first barrel head and a portion of the second barrel head, the tubular cover may or may not be in contact with the outside surface of either barrel head, as the staves extend further than the outside surface of the first barrel head and further than the outside surface of the second barrel head. That is, because the barrel heads are recessed relative to the ends of the staves, depending upon size and configuration, the tubular cover may or may not contact the outside surface of the first and/or second barrel heads.

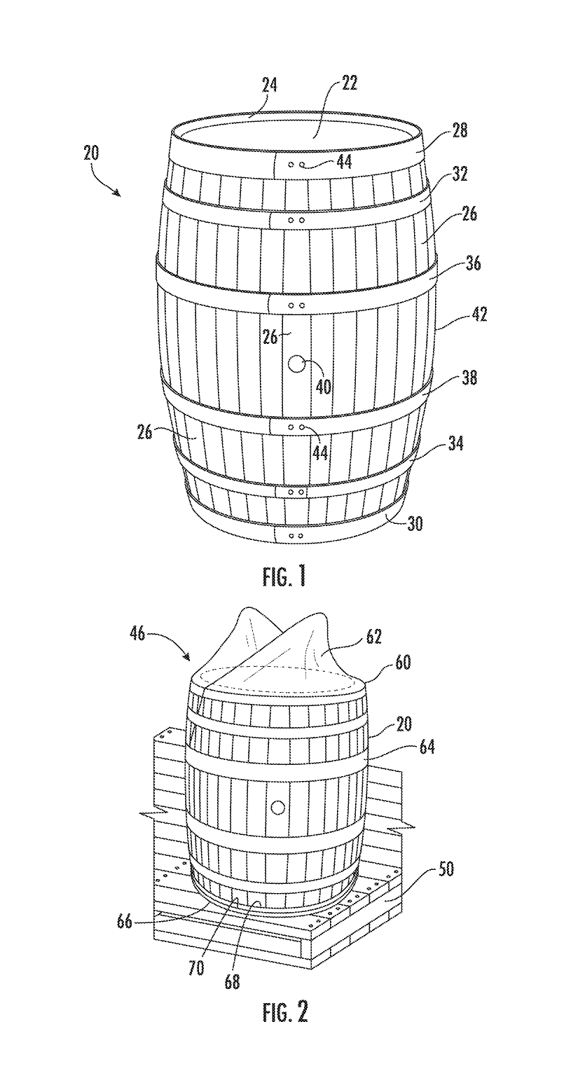

FIG. 1 is a schematic perspective view of wooden barrel 20 in an upright position with upper head 22, chime 24, lower head and lower chime (not illustrated), staves 26, upper head hoop 28, lower head hoop 30, upper quarter hoop 32, lower quarter hoop 34, upper bilge hoop 36, lower bilge hoop 38, bung 40 (shown installed in a bung hole through wooden stave 26), and bilge 42. The hoops are held together with rivets 44 which hold end regions of the metal hoops together. Hoops 28, 30, 32, 34, 36, and 38 may each be held in place on the barrel with one, two, or more tacks (not illustrated) which pass through the hoops and a short distance into wooden staves 26. Bilge 42 is the widest part of barrel 20. Bung 40 is hammered into a passageway (bung hole) through a stave 26. Bung 40 can be can be made of wood, cork, rubber, silicone, polyurethane, etc.

FIG. 2 is a schematic perspective view of a barrel-with-cover assembly 46 comprising wooden barrel 20 in an upright position on pallet 50 with cover 60 thereon. Cover 60 has closed end 62 and tubular portion 64 terminating in open end 66 having casing 68 providing a casing enclosure which encloses a passageway within which is elastic loop 70 under tension.

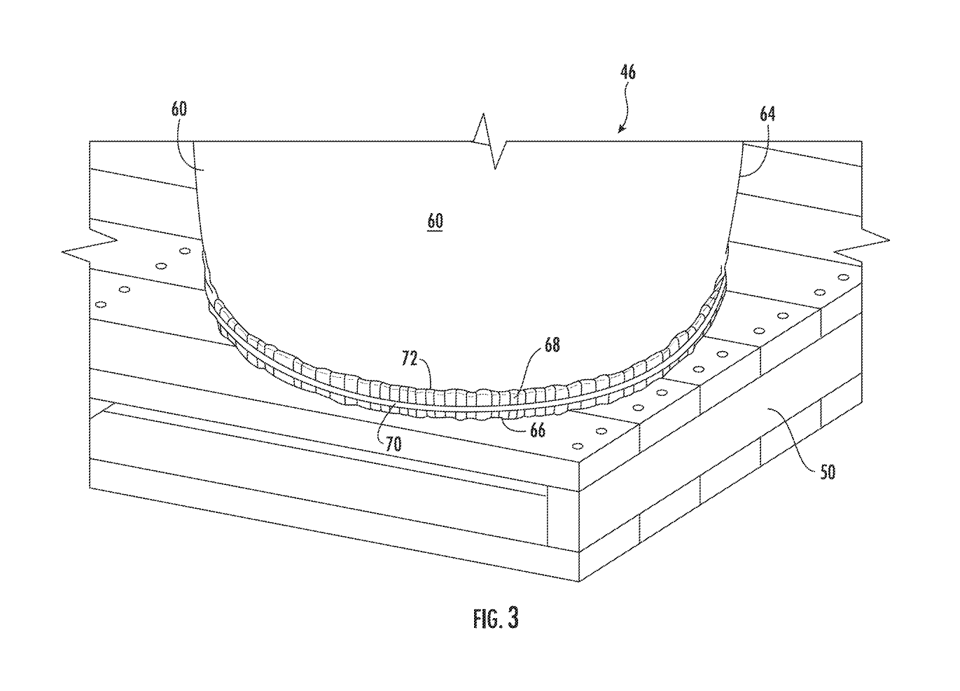

FIG. 3 is an enlarged view of a portion of barrel-with-cover assembly 46 with the barrel 20 (for clarity of illustration, barrel 20, which is under cover 60, is not illustrated in FIG. 3) in an upright position on pallet 50 with cover 60 over barrel 20. Cover 60 terminates in open end 66, with the film from which cover 60 is made doubling back and affixed to itself (e.g., by heat sealing, adhesive, etc) to form casing 68 having therewithin a casing enclosure providing a confined domain within which is a loop of elastic strap 70 under tension. Puckering 72 of cover 60 at open end 66 is caused by open end 66 having an inside perimeter larger than the outside perimeter of the lower end of the barrel 20, as the means for gathering (in this case, the tensioned loop of elastic strap 70) forces the inside of casing 68 against the outer surface of the barrel 20 at open end 66. Open end 66 of cover 60 is maintained in limited contact against the outer surface of barrel 20 by the means for gathering.

FIG. 4 is a schematic perspective view of barrel-with-cover assembly 80 in which four barrels 82, 84, 86, and 88 are in upright position on pallet 90, with multi-barrel cover 92 covering barrels 82, 84, 84, and 88. Cover 92 has closed end 93 covering the top heads of all four barrels 82, 84, 84, and 88. Cover 92 also has open end 94, with the film from which cover 92 is made doubling back and affixed to itself to form casing 96 having therewithin a casing enclosure providing a confined domain within which is a loop of elastic strap 70 under tension. Puckering of casing 96 at open end 94 is present because open end 94 has inside perimeter larger than the outside perimeter of the shortest passageway around the combined lower ends of all four barrels 82, 84, 86, and 88 in their arrangement on pallet 90, as open end 94 must be large enough to pass over the shortest passageway around the combined bilges 98 of all four barrels 82, 84, 86, and 88. Elastic strap 70, under tension, serves as the means for gathering cover 92 at open end 94, forcing the inside of cover 92 against the outer surface of barrels 82, 84, 84, and 88 at open end 94. Open end 94 of cover 92 is maintained in limited contact against the outer surface of barrels 82, 84, 84, and 88 by the means for gathering.

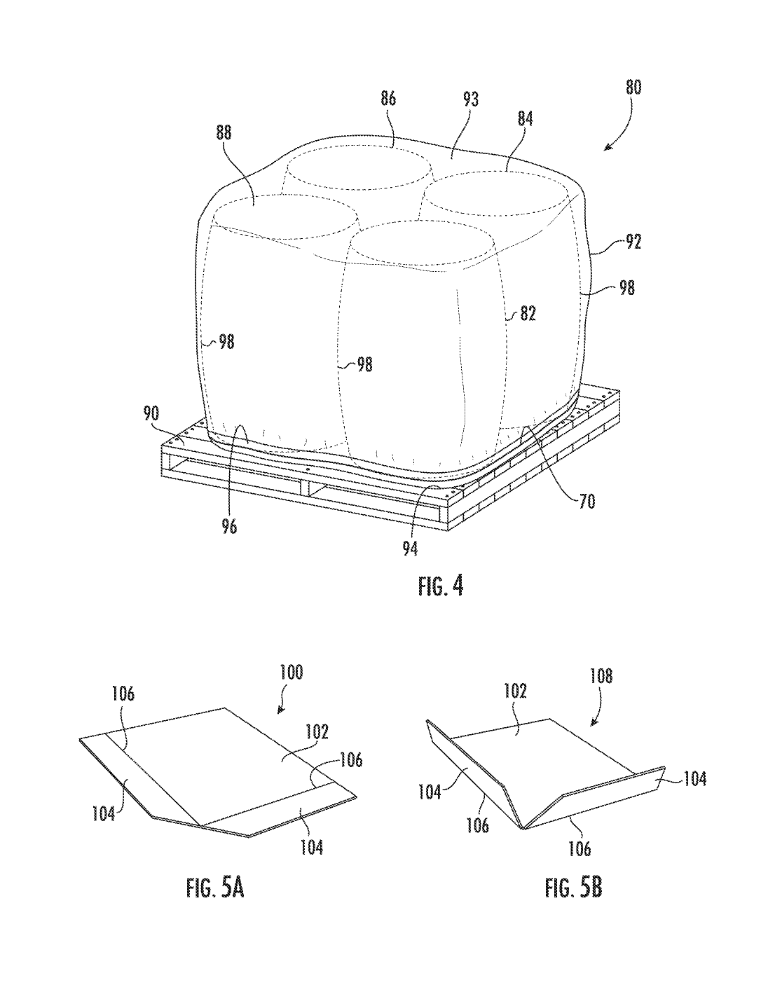

FIG. 5A is a perspective view of a portion of foldable barrel pad 100 (if sized for a single barrel) or pallet pad 100 (if sized to cover the top surface of a pallet which may hold, for example, one, two, four, six, or eight barrels) for placement on a top surface of a pallet, with the barrels to be in upright position on top of barrel/pallet pad 100. Barrel/pallet pad 100 has base portion 102 which remains in contact with the top surface of the pallet and on top of which the barrel or barrels rest, and folding portions 104 which can be folded up along fold lines 106 illustrated for folded barrel/pallet pad 108 as illustrated in FIG. 5B. Alternatively, although not illustrated, the barrel/pallet pad can comprise the base portion without any folding portions. In all embodiments utilizing a barrel or pallet pad, the pad acts as a cover over the bottom of the barrels to provide a high ethanol environment under the bottom of the barrels, and can also act as an absorbent to soak up liquid passing through barrels or condensing between the barrel and the cover.

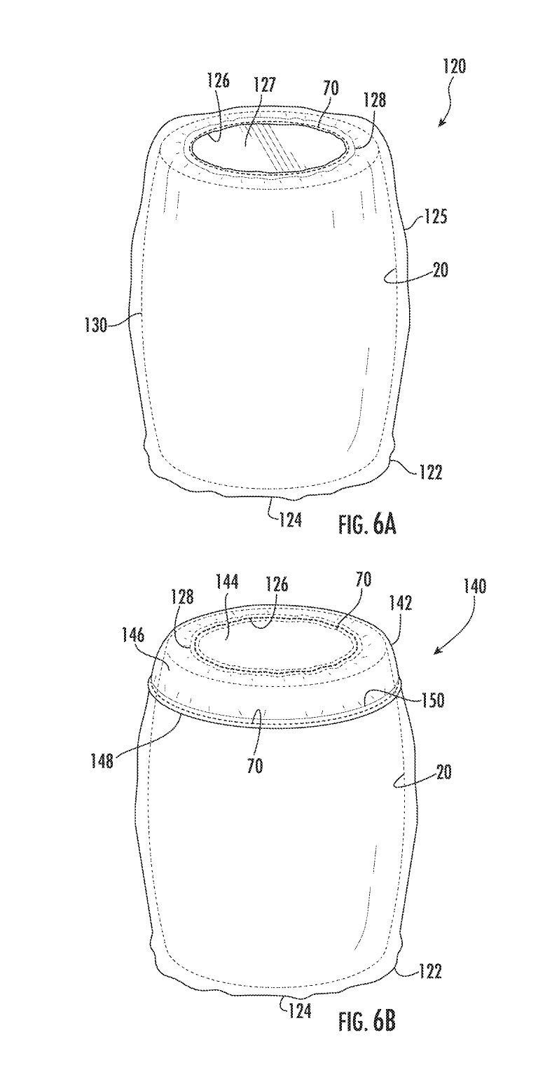

FIG. 6A is a perspective view of a schematic of an alternative barrel-with-cover assembly 120 with barrel 20 having cover 122 thereover. Cover 122 has closed end 124, tubular portion 125, and open end 126, with the film from which cover 122 is made doubling back and affixed to itself (e.g., by heat sealing, adhesive, etc) to form casing 128 having therewithin a casing enclosure providing a confined domain within which is a loop of elastic strap 70 therein. Puckering of cover 122 at open end 126 is caused by open end 126 having an inside perimeter large enough to pass over barrel bilge 130, with elastic strap loop 70 contracting back towards its unstretched dimension and thereby providing a means for gathering cover 122 at open end 126 in barrel-with-cover assembly 120 of FIG. 6A. Open end 126 of cover 122 is maintained in limited contact with the outer surface of barrel 20 by the means for gathering.

Although the vertical position of the barrel 20 and cover 122 can be as illustrated in FIG. 6A, with open end 126 of cover being over top head 127 of barrel 20, during aging it may be preferred to flip barrel 20 upside down so that top head 127 of barrel 20 becomes bottom head 127 of barrel 20, to allow the passageway through open end 126 of cover 122 to allow fluid between barrel 20 and cover 122 to evaporate or otherwise escape from between cover 122 and barrel 20.

FIG. 6B is a perspective view of a schematic of an alternative barrel-with-cover assembly 140 with barrel 20 having first cover 122 thereover. First cover 122 is identical with first cover 122 of FIG. 6A, and therefore has closed end 124 and open end 126, with the film from which first cover 122 is made doubling back and affixed to itself (e.g., by heat sealing, adhesive, etc) to form casing 128 having therewithin a casing enclosure providing a confined domain within which is a loop of elastic strap 70 therein. First cover 122 is puckered at open end 126, as described for FIG. 6A. Open end 126 of first cover 122 is maintained in limited contact with the outer surface of barrel 20 by the means for gathering.

Barrel-with-cover assembly 140 further comprises second cover 142 thereover. Second cover 142 has closed end 144 that covers the top of barrel 20 and also overlaps a portion of first cover 122. Second cover 142 also has tubular portion 146 that further overlaps first cover 122 and which terminates in second open end 148, with the film from which second cover 142 is made being doubled back and affixed to itself (e.g., by heat sealing, adhesive, etc) to form casing 150 having therewithin a casing enclosure providing a confined domain within which is a tensioned elastic strap loop 70. Second cover 142 is puckered at open end 148 because elastic strap loop 70 maintains itself in higher tension than is second cover 142 at open end 148. In this manner, open end 148 of cover 142 is maintained in limited contact with the outer surface of barrel 20 by the means for gathering.

Although the vertical position of the barrel 20 and first cover 122 and second cover 142 may be as illustrated in FIG. 6A, with open end 126 of cover being over top head 127 of barrel 20, during aging it may be preferred to flip barrel 20 upside down so that closed end 144 of second cover 142 is beneath the bottom head of barrel 20, with the closed end of second cover being provided with a liquid exit port, to allow the passageway through open end 126 of cover 122 to allow fluid between barrel 20 and cover 122 to escape from between first and second covers 122 and 142, and barrel 20.

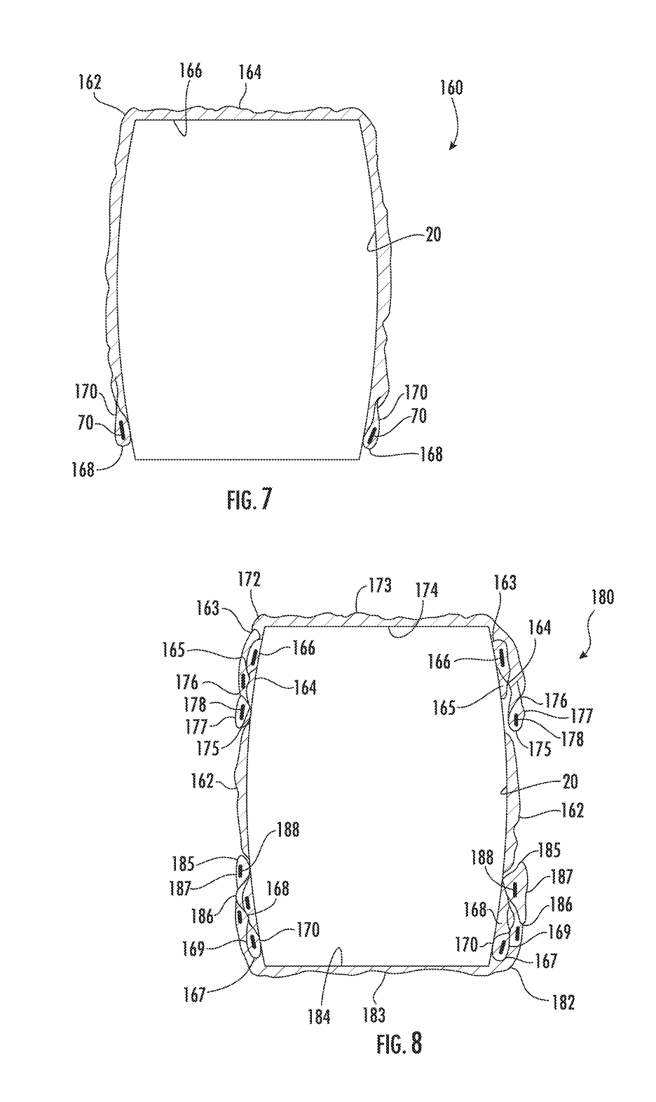

FIG. 7 is a schematic longitudinal cross-sectional view of barrel-with-cover assembly 160 with barrel 20 having cover 162 thereover, with cover 162 having closed end 164 covering barrel top head 166 and open end 168 near the bottom end of the staves, with open end 168 of cover 162 being doubled back and sealed to itself to make casing 170 defining a casing enclosure, with elastic strap loop 70 under tension inside the enclosure formed by casing 170.

FIG. 8 is a schematic longitudinal cross-sectional view of barrel-with-cover assembly 180 with barrel 20 having first cover 162 over the barrel staves, second cover 172 covering barrel top head 174 and overlapping first cover 162, and third cover 182 covering barrel bottom head 184 and also overlapping first cover 162.

First cover 162 has first open end 163 the film being doubled back and sealed at seal 164 to make first casing 165 providing a first casing enclosure in which is first elastic strap loop 166 which is the means for gathering first cover 162 at first open end 163 whereby first cover 162 is in limited contact with barrel 20 at first open end 163. First cover 162 also has second open end 167 with the film again being doubled back and sealed at seal 168 to make second casing 169 providing a second casing enclosure in which is second elastic strap loop 170 which is the means for gathering first cover 162 at second open end 167 whereby first cover 162 is in limited contact with barrel 20 at second open end 167.

Second cover 172 has first closed end 173 covering barrel top head 174, with second cover extending down to third open end 175 at which the film is doubled back and sealed at seal 176 to make third casing 177 providing a third casing enclosure in which is third elastic strap loop 178 which is the means for gathering second cover 172 at third open end 175 whereby second cover 172 is in limited contact with barrel 20 at third open end 175.

Third cover 182 has second closed end 183 covering barrel bottom head 184, with third cover extending down to fourth open end 185 at which the film is doubled back and sealed at seal 186 to make fourth casing 187 providing a fourth casing enclosure in which is fourth elastic strap loop 188 which is the means for gathering third cover 182 at fourth open end 185 whereby third cover 182 is in limited contact with barrel 20 at fourth open end 185.

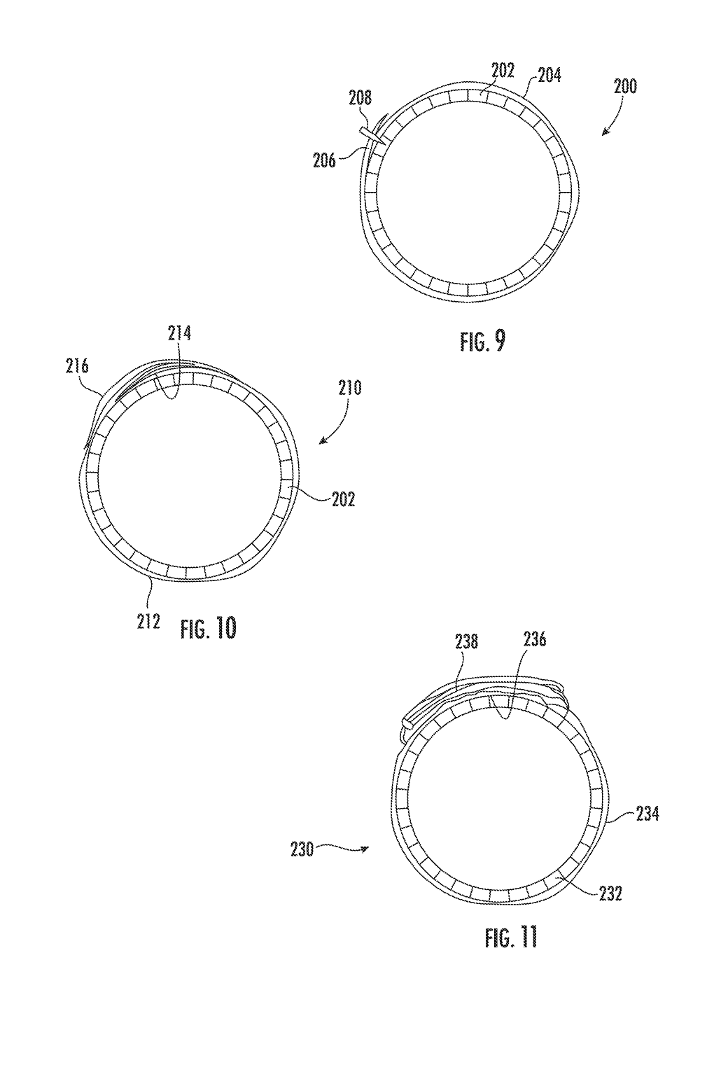

FIG. 9 is a schematic transverse cross-sectional view of barrel-with-cover assembly 200 comprising barrel 202 having tubular cover 204 held in limited contact therewith by folding tubular cover 204 back upon itself to make at least one fold 206 at an open end of cover 204, and thereafter holding at least one fold 206 in place by passing pin 208 (or staple) through fold 206, with pin 208 passing into barrel 202 thereby holding pin 208 and fold 206 in place.

FIG. 10 is a schematic transverse cross-sectional view of barrel-with-cover assembly 210 comprising barrel 202 having tubular cover 212 held in limited contact therewith by folding tubular cover 212 back upon itself to make at least one fold 214 at an open end of cover 212, and thereafter holding the at least one fold 214 in place by adhering the fold in place with an adhesive, including pressure sensitive adhesive tape 216 over the at least one fold at the open end of cover 212.

FIG. 11 is a schematic transverse cross-sectional view of barrel-with-cover assembly 230 comprising barrel 232 having tubular cover 234 held in limited contact therewith by gathering a portion 236 of tubular cover 234 unto itself at an open end of cover 234, and thereafter holding the gathered portion of tubular cover 234 in place with an elastic strap 238 with hooks passing through grommets in cover 234, or a clamp in place of the adhesive, or an adhesive (including pressure sensitive adhesive in a tape article such as a duct tape) held in tension.

The tubular cover can comprise, or be made from, a film as described in U.S. Ser. No. 14/599,820, entitled “Process For Reducing Ethanol Loss While Developing Desirable Organoleptics During Wooden Barrel Aging Of Alcoholic Beverage,” filed 19 Jan. 2015, and U.S. Ser. No. 14/333,867, entitled Process For Reducing Ethanol Loss While Developing Desirable Organoleptics During Wooden Barrel Aging Of Alcoholic Beverage,” filed 17 Jul. 2014, both of which are above incorporated, in their respective entireties, by reference thereto.

The film can have an oxygen transmission rate of at least 0.5 cc/m²/day and an ethanol transmission rate of less than 30 g/m²/day, so that during aging the alcoholic beverage acquires or produces at least one flavor component selected from the group consisting of vanillin, syringaldehyde, isoeugenol, o-cresol, 2-methoxy-4-methylphenol, 4-methylsyringol, 4-ethylguaiacol, 4-vinylguaiacol, vanillyl methyl ketone, methoxyeugenol, sinapaldehyde, and furfural, so that the aged alcoholic beverage contains the at least one flavor component in an amount of at least 50% relative to an amount of the same flavor component in a control alcoholic beverage aged in at least one control wooden barrel which is uncovered during aging.

The tubular cover can comprise a film designed and covering the barrel so that during aging, the alcoholic beverage produces at least two of the flavor components in an amount of at least 75% relative to the amount of the same flavor components in the control alcoholic beverage which is aged in at least 2 control wooden barrels. In an embodiment, the at least two flavor components can be selected from the group consisting of vanillin, isoeugenol, o-cresol, 2-methoxy-4-methylphenol, 4-methylsyringol, 4-vinylguaiacol, vanillyl methyl ketone, and sinapaldehyde. In an embodiment, the at least two flavor components are selected from the group consisting of isoeugenol, 4-vinylguaiacol, and vanillyl methyl ketone.

In an embodiment, the tubular cover can comprise a film designed and covering the barrel so that during aging the alcoholic beverage produces the at least three of the flavor components in an amount of at least 75% relative to the amount of the same flavor components in the control alcoholic beverage which is aged in at least 4 control wooden barrels.

In an embodiment, the tubular cover can comprise a film designed and covering the barrel so that the aged alcoholic beverage further comprises at least one flavor component selected from the group consisting of eugenol, furfural, and cis-β-methyl-γ-octalactone in an amount of more than 100% relative to the amount the same flavor compound in the control alcoholic beverage.

In an embodiment, the tubular cover can comprise a film designed and covering the aged alcoholic beverage so that at least one flavor component selected from the group consisting of eugenol and furfural is present in an amount of more than 100% relative to the amount of eugenol in the control alcoholic beverage.

In an embodiment, the tubular cover can comprise a film designed and covering the aged alcoholic beverage so that the aged alcoholic beverage further comprises eugenol in an amount of more than 100% relative to the amount of eugenol in the control alcoholic beverage.

In an embodiment, the tubular cover comprises a film having an oxygen transmission rate of from 0.5 cc/m²/day to 49.9 cc/m²/day. In an embodiment, the tubular cover comprises a film having an oxygen transmission rate of from 5 cc/m²/day to 49.9 cc/m²/day. In an embodiment, the tubular cover comprises a film having an oxygen transmission rate of from 10 cc/m²/day to 49.9 cc/m²/day. In an embodiment, the tubular cover comprises a film having an oxygen transmission rate of at least 20 cc/m²/day. In an embodiment, the tubular cover comprises a film having an oxygen transmission rate of at least 30 cc/m²/day. In an embodiment, the tubular cover comprises a film having an oxygen transmission rate of at least 40 cc/m²/day. In an embodiment, the tubular cover comprises a film having an oxygen transmission rate of at least 50 cc/m²/day.

In an embodiment, the tubular cover comprises a multilayer film comprising polyolefin in an amount of from 50 to 82 percent, based on total film weight, and cyclic olefin copolymer in an amount of from 18 to 50 weight percent based on total film weight, with the cyclic olefin copolymer being present in a blend with polyolefin, the film having a thickness of from 0.5 to 4 mils.

In an embodiment, the multilayer film comprises three layers including two outer layers and one inner layer, the inner layer comprising a blend of from 20 to 80 wt % ethylene norbornene copolymer and from 80 to 20 wt % ethylene/alpha-olefin copolymer, and the alcoholic beverage product is selected from distillate and wine.

In an embodiment, the tubular cover comprises a film having an oxygen transmission rate of at least 5 cc/m²/day and an ethanol transmission rate of from 0.1 to 20 g/m²/day, and the film comprises polyolefin, and the film has a thickness of from 0.5 to 5 mils.

In an embodiment, the tubular cover comprises a film having an oxygen transmission rate of at least 50 cc/m²/day and an ethanol transmission rate of 0.1 to 1 g/m²/day, and the film further comprises a cyclic olefin copolymer after the alcoholic beverage has been aged for at least 2 months.

In an embodiment, the tubular cover comprises a film containing a blend of polyolefin and cyclic olefin copolymer, wherein the cyclic olefin copolymer comprises ethylene/norbornene copolymer, and the ethylene norbornene copolymer is present in the film in an amount of from 15 to 70 weight percent based on total film weight, and the polyolefin is present in the film in an amount of from 30 to 85 wt % based on total film weight, and the film has a thickness of from 0.5 to 4 mils, an oxygen transmission rate of from 150 to 500 cc/m²/day, an ethanol transmission rate of less than 1 g/m²/day, and a moisture vapor transmission rate less than 1 g/m²/day.

In an embodiment, the tubular cover comprises a film such upon termination of aging, and upon being diluted with water to have an alcohol by volume of 30%, the alcoholic beverage exhibits an aroma and flavor, upon evaluation in accordance with ASTM E1879-00 Sensory Evaluation of Beverages Containing Alcohol together with ASTM E1885-04 Standard Method for Sensory Analysis—Triangle Test, indistinguishable relative to the aged control alcoholic beverage from the at least one control barrel, the aged control alcoholic beverage also having an alcohol by volume of less than 30% or being diluted with water to have an alcohol by volume of 30%. In an embodiment, the tubular cover comprises a film having an oxygen transmission rate of from 0.5 cc/m²/day to 49.9 cc/m²/day.

In an embodiment of the process aspects herein, the empty barrels are placed on the pallet after a tray has been placed on the pallet. The tray may be a plastic tray. The pallet can be sized for 4 barrels, 6 barrels, or 8 barrels. After filling, all the barrels on the pallet may be covered with a single cover made from film described above. The group of barrels on the pallet could then be put into a warehouse for aging.

Using the barrel-with-cover assembly as described above, the use of an elastic strap make the cover (or covers) easy to apply, and easy to remove if a sample or other handling is needed. Moreover, if there is a leaking barrel, the leaking liquid would not be collected at the bottom of the barrel if (i) the cover or bag is open at the bottom, (ii) the cover at the bottom and is perforated.

In an embodiment, the process is carried out so that during aging the alcoholic beverage inside the barrel decreases in weight due to both (i) an angels' share portion of the alcoholic beverage diffusing through the at least one wooden barrel evaporating off the outer surface of the at least one barrel, and (ii) a devil's cut portion of the alcoholic beverage diffusing into the wood of the at least one wooden barrel, and remaining in the wood of the at least one wooden barrel, wherein the decrease in weight of the alcoholic beverage liquid inside the barrel is at least 30 percent less than a corresponding decrease in weight of a control alcoholic beverage inside a control wooden barrel which is uncovered during aging. In an embodiment, the aged alcoholic beverage, either having an alcohol by volume of less than 30% or upon being diluted with water to have an alcohol by volume of 30%, exhibits an aroma and flavor, upon evaluation in accordance with ASTM E1879-00 Sensory Evaluation of Beverages Containing Alcohol together with ASTM E1885-04 Standard Method for Sensory Analysis—Triangle Test, indistinguishable relative to the aged control alcoholic beverage from the at least one control wooden barrel, the aged control alcoholic beverage also having an alcohol by volume of less than 30% or being diluted with water to have an alcohol by volume of 30%. In an embodiment, the tubular cover comprises a film having an oxygen transmission rate of from 0.5 cc/m²/day to 49.9 cc/m²/day.

In an embodiment, the process is carried out so that during aging the decrease in weight of the alcoholic beverage liquid inside the at least one barrel is at least 40 percent less than the corresponding decrease in weight of the control alcoholic beverage inside the at least one control barrel.

In an embodiment, the process is carried out so that during aging the decrease in weight of the alcoholic beverage liquid inside the at least one barrel is at least 50 percent less than the corresponding decrease in weight of the control alcoholic beverage inside the at least one control barrel.

The tray placed on the pallet may be a collapsible tray as illustrated in FIG. 5, described above.

1: A barrel-with-cover assembly comprising:
(A) a barrel comprising a top head and a bottom head with the barrel, and a plurality of wooden staves each contacting and extending between the top head and the bottom head, each of the wooden staves having an upper end and a lower end, the wooden staves being maintained in lengthwise contact with one another by a plurality of metal hoops around an outside surface of the staves, the barrel having a maximum transverse circumference at a barrel bilge;
(B) a cover positioned over and covering at least a portion of an outside surface of the barrel including at least a portion of the outside surface of the staves, the cover having at least one open end having a perimeter greater than a maximum outside circumference of the outer surface of the barrel, the open end of the cover being maintained in limited contact against the outer surface of the barrel by means for gathering the cover.

2: The barrel-with-cover assembly according to claim 1, wherein the barrel contains a liquid comprising ethanol.

3: The barrel-with-cover assembly according to claim 1, wherein the cover is a tubular cover comprises a pouch having a first end which is closed a second end which is the open end.

4: The barrel-with-cover assembly according to of claim 3, wherein:
(A) the tubular cover is a first tubular cover with the first end which is closed covering the top head of the barrel with the barrel in an upright position, and the means for gathering the tubular cover being a first means for gathering the first tubular cover at the open second end of the first tubular cover, with the first tubular covering the staves to a position below the barrel bilge, and
(B) a second tubular cover with a second closed end covering the bottom head of the barrel with the barrel in the upright position, the second tubular cover having a second means for gathering at a second open end of the second tubular cover, with the second tubular cover covering the staves to a position above the first means for gathering at the first open end of the first tubular cover, the second tubular cover overlapping the first tubular cover.

5: The barrel-with-cover assembly according to claim 4, wherein at least a portion of the second tubular cover covering the bottom head comprises a liquid exit port.

6: The barrel-with-cover assembly according to claim 1, wherein the second open end of the second tubular cover is outside the first open end of the first tubular cover.

7: The barrel-with-cover assembly according to claim 1, wherein the second open end of the second tubular cover is inside the first open end of the first tubular cover.

8: The barrel-with-cover assembly according to claim 3, wherein:
(A) the tubular cover is a first tubular cover with the closed first end covering the bottom head of the barrel with the barrel in an upright position, and the means for gathering being a first means for gathering at the open end of the first tubular cover, with the open end of the first tubular cover covering the staves to position above the barrel bilge, and the barrel-with cover assembly further comprises
(B) a second tubular cover with a second closed end covering the top head of the barrel with the barrel in the upright position, and the second tubular cover having a second means for gathering at a second open end of the second tubular cover, the second tubular cover overlapping the first tubular cover, with the second open end of the second tubular cover covering the staves to position below the first means for gathering at the first open end of the first tubular cover.

9: The barrel-with-cover assembly according to claim 8, wherein at least a portion of the first tubular cover covering the bottom head comprises a liquid exit port.

10: (canceled)

11: (canceled)

12: The barrel-with-cover assembly according to claim 1, wherein the cover is a tubular cover and the means for gathering the tubular cover is a first means for gathering the tubular cover and is at the first open end of the tubular cover, and the tubular cover has a second open end and a second means for gathering the tubular cover at the second open end of the tubular cover.

13: The barrel-with-cover assembly according to claim 12, wherein:
(A) the tubular cover is a first tubular cover, the first tubular cover covering the barrel bilge, the first open end of the first tubular cover being between the barrel bilge and the lower end of the wooden staves with the barrel in an upright position with the first means for gathering the first tubular cover being at the first open end of the first tubular cover, the first open end of the being maintained in limited contact against the outer surface of the barrel by means for gathering at the first open end of the first tubular cover, and the second open end of the first tubular cover being between the barrel bilge and the upper end of the wooden staves with the barrel in the upright position with the second means for gathering the first tubular cover being at the second open end of the first tubular cover, the second open end being maintained in limited contact against the outer surface of the barrel by means for gathering at the second open end of the first tubular cover;
(B) a second tubular cover having a first closed end covering the top head of the barrel with the barrel in an upright position and a third open end opposite the first closed end, the second tubular cover overlapping the first tubular cover, the second tubular cover having a third means for gathering at a third open end of the second tubular cover, the third open end being maintained in limited contact against the outer surface of the barrel by a third means for gathering at the third open end of the second tubular cover; and
(C) a third tubular cover having a second closed end covering the bottom head of the barrel with the barrel in an upright position and a fourth open end opposite the second closed end, the third tubular cover overlapping the first tubular cover, the third tubular cover having a fourth means for gathering at the fourth open end of the third tubular cover, the fourth open end being maintained in limited contact against the outer surface of the barrel by a forth means for gathering at the fourth open end of the third tubular cover.

14-21: (canceled)

22: The barrel-with-cover assembly according to claim 1, wherein the tubular cover covers at least 75% of an outer surface of the staves.

23: The barrel-with-cover assembly according to claim 1, wherein the at least one means for gathering comprises at least one member selected from the group consisting of elastic strap, clip, staple, pin, adhesive, drawstring, tape with pressure sensitive adhesive, touch fastener, hook-and-loop fastener, hook-and-pile fastener, slidingly engaging fastener, bundle tie, clamp, and elastic strap.

24: The barrel-with-cover assembly according to claim 23, wherein the means for gathering the tubular cover is an elastic strap in contact with the tubular cover, and wherein a portion of the film is held in limited contact with the barrel by a contractive force exerted by the elastic strap.

25: The barrel-with-cover assembly according to claim 24, wherein the elastic strap is present as an elastic loop, with the elastic loop having a relaxed length smaller than a circumference of the barrel at the upper end of the staves and the lower end of the staves.

26-30: (canceled)

31: The barrel-with-cover assembly according to claim 1, further comprises a pallet with the barrel in the upright position, the barrel resting upon an upper surface of the pallet and further comprising a tray between the pallet and the barrel.

32: (canceled)

33: The barrel-with-cover assembly according to claim 31, wherein a portion of the tubular cover extends down to cover an edge of the tray under the barrel or to cover or be covered by a portion of the tray extending upward over a lower portion of the outer surface of the barrel, with the means for gathering the tubular cover comprising an elastic band around the tray, with the elastic band:
(i) in contact with the tubular cover and forcing the tubular cover into a gathered configuration against the edge of the tray, or
(ii) in contact with the tubular cover and forcing the tubular cover into a gathered configuration against the upwardly extending portion of the tray, or
(iii) in contact with the upwardly extending portion of the tray which in turn forces the open end of the tubular cover into a gathered configuration against the outer surface of the barrel.

34: (canceled)

35: The barrel-with-cover assembly according to claim 31, wherein the pallet has a plurality of barrels resting upon the upper surface thereof, each barrel resting in the upright position.

36-49: (canceled)

50: The barrel-with-cover assembly according to claim 35, wherein the assembly comprises a plurality of covers and the first cover has a first open end having a means for gathering the first cover in limited contact with the barrel staves at a location below the barrel bilge, the first cover being sized to cover at least a portion of the outside surface of the barrel staves, and a second cover has a first closed end and a third open end and covers the bottom head of the barrels in the upright position, and wherein the second cover has a liquid exit port.

51: (canceled)

52: A process for aging an alcoholic beverage in a wooden barrel, comprising
(A) filling an empty wooden barrel with an alcoholic beverage to produce a filled wooden barrel, a barrel comprising a top head and a bottom head, and a plurality of wooden staves each contacting and extending between the top head and the bottom head, each of the wooden staves having an upper end and a lower end, the wooden staves being maintained in lengthwise contact with one another by a plurality of metal hoops around an outside surface of the staves, the barrel having a maximum transverse circumference at a barrel bilge;
(B) closing the wooden barrel after filling the barrel, to make a sealed, filled barrel;
(C) covering at least a portion of the wooden barrel by placing at least one cover thereover, to produce a barrel-with-cover assembly according to of claims 1-52; and
(D) aging the alcoholic beverage in the barrel-with-cover assembly.

53-59: (canceled)
